(19) United States
(12) Patent Application Publication
(10) Pub. No.: US 2025/0118901 A1
(43) Pub. Date: Apr. 10, 2025

(54) CONFIGURABLE QUADRIFILAR HELIX ANTENNA

(71) Applicants: 2J ANTENNAS USA, CORPORATION, Gilbert, AZ (US); 2J Antennas, S.R.O, Bardejov (SK); 2J Antennas UK, LTD, Waterlooville (GB)

(72) Inventor: David Noble, Waterlooville (GB)

(73) Assignees: 2J ANTENNAS USA, CORPORATION, Gilbert, AZ (US); 2J Antennas, S.R.O, Bardejov (SK); 2J Antennas UK, LTD, Waterlooville, EN (GB)

(21) Appl. No.: 18/833,390

(22) PCT Filed: May 12, 2022
(86) PCT No.: PCT/US22/28952

§ 371 Date: Jul. 26, 2024

(51) Int. Cl. H01Q 11/08; H01Q 3/36

(52) U.S. Cl. CPC H01Q 11/08; H01Q 3/36

(57) ABSTRACT

A configurable quadrifilar helix antenna is disclosed having a first helical antenna, a second helical antenna, a third helical antenna, and a fourth helical antenna each disposed on a cylindrical dielectric. On a bottom portion of the cylindrical dielectric is coupled a configurable circuit. The configurable circuit includes a first hybrid coupler and a second hybrid coupler, whereby based on linkage settings to the first and second hybrid coupler, the quadrifilar helix antenna is configured to have a first phasing sequence generating a first radiation pattern. Alternatively, the quadrifilar helix antenna may have a second phasing sequence generating a second radiation pattern.

### TECHNICAL FIELD

This invention relates to antennas; more particularly, quadrifilar helix antennas comprising a configurable circuit.

### BACKGROUND ART

A quadrifilar helix antenna operates by providing equal signals to four radiating elements (filars), each with a 90° phase shift in quadrature. This phasing is typically achieved by using a network of couplers, baluns, or delay lines. The phasing sense, in tandem with the helix winding sense determines the polarization of the electric field, and the radiation pattern characteristics to and from the antenna.

Circularly polarized signals are commonly used in satellite applications as they propagate in all planes, reducing signal loss and helping to mitigate against anomalies caused by atmospheric conditions, multipath reflections or fading. To maximize signal power transfer, the receive and transmit antennas should be configured to the same polarization. Right hand circular (RHC) polarization antennas are prevalent in satellite systems, but many applications or test scenarios require left hand circular (LHC) polarization.

### SUMMARY OF INVENTION

### Technical Problem

Existing antennas have fixed radiation patterns and polarization, thereby having a single output configuration. Making changes to an antenna to the radiation pattern and/or polarization is difficult and cost prohibitive. Miniaturized quadrifilar helix antennas are usually configured to transmit or receive RHC radio signals, with an end-fire propagation characteristic. In many applications however, it is required to use LHC signals.

There are no existing solutions that permits the same antenna assembly to be configured according to particular radiation pattern requirements for specific applications.

### Solution to Problem

Disclosed is a configurable quadrifilar helix antenna comprising a cylindrical dielectric having a first helical antenna, a second helical antenna, a third helical antenna, and a fourth helical antenna disposed thereon. On a bottom portion of the cylindrical dielectric is coupled a configurable circuit. The configurable circuit comprises a first hybrid coupler and a second hybrid coupler, whereby based on settings to the first and second hybrid coupler, the quadrifilar helix antenna may comprise a first phasing sequence having a first radiation pattern. Alternatively, the quadrifilar helix antenna may comprise a second phasing sequence having a second radiation pattern.

### Advantageous Effects of Invention

The configurable circuit allows the quadrifilar helix antenna to change radiation pattern by merely changing linkages in the circuit. Manufacturing antennas with various configurations (RHC vs LHC, end fire vs back fire) can be simplified by use of like parts such as the configurable circuit, antenna assembly, and cylindrical dielectric.

The polarization can easily be changed by altering the orientation and/or position of the configurable circuit.

Other features and benefits will be appreciated by one having skill in the art upon a thorough review of the instant disclosure.

### BRIEF DESCRIPTION OF THE DRAWINGS

Other features, combinations, and embodiments will be appreciated by one having the ordinary level of skill in the art of antennas and accessories upon a thorough review of the following details and descriptions, particularly when reviewed in conjunction with the drawings, wherein:

FIG. 1 shows a perspective view of configurable quadrifilar helix antenna in accordance with a first illustrated embodiment;

FIG. 2A shows a top view of the configurable quadrifilar helix antenna having a first phasing sequence according to the first illustrated embodiment;

FIG. 2B shows a side view of the configurable quadrifilar helix antenna having a first radiation pattern according to the first illustrated embodiment;

FIG. 3A shows a top view of the of the configurable quadrifilar helix antenna having a second phasing sequence according to the first illustrated embodiment;

FIG. 3B shows a side view of the configurable quadrifilar helix antenna having a second radiation pattern according to the first illustrated embodiment;

FIG. 4 shows a top view of configurable circuit according to the first illustrated embodiment;

FIG. 5 shows a schematic of the first phasing sequence according to the first illustrated embodiment;

FIG. 6 shows a schematic of the second phasing sequence according to the first illustrated embodiment;

FIG. 7 shows a bottom view of a configurable quadrifilar helix antenna in accordance to a second illustrated embodiment;

FIG. 8 shows a perspective view of a configurable quadrifilar helix antenna in accordance to a third illustrated embodiment; and

FIG. 9 shows a schematic of the configurable circuit in accordance with a fourth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “hybrid coupler” means a passive device used for splitting signals.

Unless explicitly defined herein, terms are to be construed in accordance with the plain and ordinary meaning as would be appreciated by one having skill in the art.

### GENERAL DESCRIPTION OF EMBODIMENTS

In one general embodiment, a configurable helix antenna is disclosed. The configurable helix antenna comprises a cylindrical dielectric having top portion and a bottom portion opposite the top portion, and a hollow center extending through the cylindrical dielectric, an antenna assembly comprising a first helical antenna having a first lower end and a first upper end opposite the first lower end, a second helical antenna having a second lower end and a second upper end opposite the second lower end, a third helical antenna having a third lower end and a third upper end opposite the third lower end, and a fourth helical antenna having a fourth lower end and a fourth upper end opposite the fourth lower end. The first through fourth helical antenna each spiral around the cylindrical substrate. A configurable circuit is disposed at the bottom portion, the configurable circuit comprising a substrate having a substrate periphery, a plurality of ports disposed on the substrate periphery, and a first hybrid coupler and a second hybrid coupler, wherein the first and second hybrid couplers are configured to alternate phasing sequence of the configurable helix antenna from a first phasing sequence having a first radiation pattern to a second phasing sequence having a second radiation pattern, and a power divider electrically coupled to each of the first and second hybrid couplers. A plurality of fasteners is coupled to the antenna assembly and further coupled to the configurable circuit.

In some embodiments, the plurality of fasteners may further comprise soldered tabs.

In some embodiments, the first lower end, second lower end, third lower end, and fourth lower end may each be coupled to one of the plurality of ports.

In some embodiments, the top portion may be configured to receive the configurable circuit.

In some embodiments, the first through fourth helical antenna may comprise a 90-degree phase shift.

In some embodiments, the first hybrid coupler and second coupler may each comprise a quadrature coupler.

In some embodiments, the configurable circuit may further comprise an antenna connector wherein the antenna connector comprises a cable.

In some embodiments, the configurable circuit may further comprise an antenna connector wherein the antenna connector comprises a thru-hole mount.

In some embodiments, the configurable circuit may further comprise a center aperture configured to receive an antenna connector.

In some embodiments, the first through fourth helical antenna may each be disposed on an antenna assembly substrate, the antenna assembly substrate being wrapped around the cylindrical dielectric.

In another general embodiment, a configurable helix antenna is disclosed. The configurable helix antenna comprises a cylindrical dielectric having top portion and a bottom portion opposite the top portion, an antenna assembly comprising a plurality of helical antennas wherein each of the plurality of helical antenna twists around the cylindrical dielectric, and a configurable circuit disposed at the bottom portion of the cylindrical dielectric. The configurable circuit comprises a first hybrid coupler and a second hybrid coupler, wherein the first and second hybrid couplers are configured to alternate phasing sequence of the configurable helix antenna from a first phasing sequence having a first radiation pattern to a second phasing sequence having a second radiation pattern.

In some embodiments, the plurality of helical antennas may further comprise a first helical antenna having a first lower end and a first upper end opposite the first lower end, a second helical antenna having a second lower end and a second upper end opposite the second lower end, a third helical antenna having a third lower end and a third upper end opposite the third lower end, and a fourth helical antenna having a fourth lower end and a fourth upper end opposite the fourth lower end.

In some embodiments, the cylindrical dielectric may further comprise a hollow center extending therethrough.

In some embodiments, the configurable circuit may further comprise a substrate having a substrate periphery, a plurality of ports disposed on the substrate periphery, and a power divider electrically coupled to both the first and second hybrid couplers.

In some embodiments, the first through fourth helical antenna may comprise a 90-degree phase shift.

In some embodiments, the first hybrid coupler and second coupler may each comprise a quadrature coupler.

In some embodiments, the configurable circuit may further comprise an antenna connector wherein the antenna connector comprises a cable.

In some embodiments, the configurable circuit may further comprise an antenna connector wherein the antenna connector comprises a thru-hole mount.

In some embodiments, the configurable helix antenna may further comprise a plurality of fasteners each coupled to the antenna assembly and further coupled to the configurable circuit.

In some embodiments, the plurality of helical antenna may be disposed on an antenna assembly substrate, the antenna assembly substrate being wrapped around the cylindrical dielectric.

### Manufacturing

Generally, the cylindrical dielectric and substrate are made of industry standard material such as ceramic, plastic polymer, or low-cost fiberglass. Examples may include FR4, Kapton or Pyralux with printed circuit design affixed thereto. Otherwise, the cylindrical dielectric and substrate can be fabricated in accordance with the level and knowledge of one having skill in the art. The antenna assembly substrate may comprise a flexible polyimide PCB for wrapping around the cylindrical dielectric.

The first through fourth helical antennas may be fabricated by printing, etching depositing, or gluing onto the antenna assembly substrate or directly onto the cylindrical dielectric.

The quadrifilar helix antenna can be open-ended or short circuit. It will be appreciated that open-ended generally provides a higher efficiency. Passive components shown may be surface mount or through hole. In some embodiments, the quadrifilar helix antenna comprises a total size similar to a battery.

Each of the components of the antenna and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### ILLUSTRATED DESCRIPTION OF EMBODIMENTS

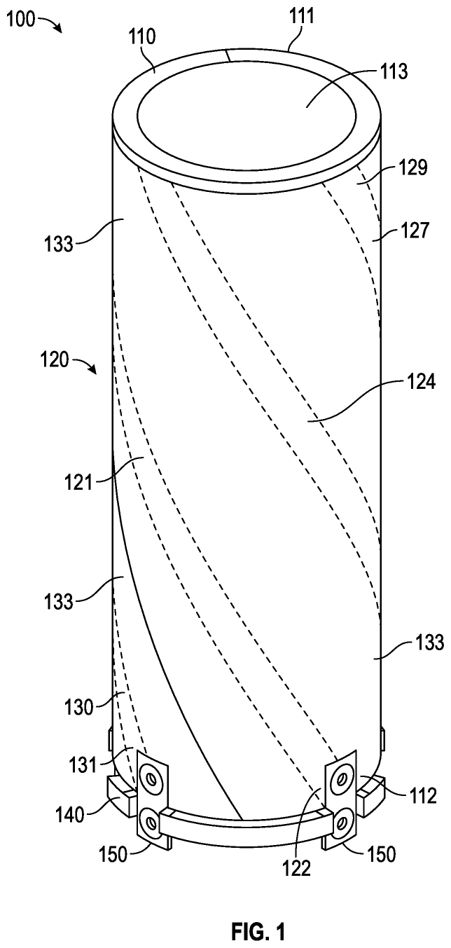

FIG. 1 shows a perspective view of configurable quadrifilar helix antenna (100) in accordance with a first illustrated embodiment. The quadrifilar helix antenna comprises a cylindrical dielectric (110) having a top portion (111) and a bottom portion (112) opposite the top portion. Disposed on the cylindrical dielectric is an antenna assembly (120) comprising a first helical antenna (121), a second helical antenna (124), a third helical antenna (127), and a fourth helical antenna (130) twisting clockwise along the cylindrical dielectric from the bottom portion to the top portion. In other embodiments, the first through fourth antennas twist counter clockwise. A configurable circuit (140) is coupled to the cylindrical dielectric at the bottom portion by a plurality of fasteners (150). The plurality of fasteners may include soldered tabs, screws, or other the like. As shown, the plurality of fasteners is coupled to the first through fourth helical antennas so as to provide an electrical connection between the configurable circuit and the antenna assembly. The first through fourth helical antennas comprises a 90-degree phase shift.

Each of the first through fourth helical antennas (121; 124; 127; 130) comprises a lower end disposed on at the bottom portion, namely a first lower end (122), a second lower end (125), a third lower end (128), and a fourth lower end (131) for the first helical antenna, second helical antenna, third helical antenna, and fourth helical antenna respectively. The first through fourth lower ends terminate at or near the bottom portion (112) and are each coupled to one of the plurality of fasteners (150) to provide the electrical connection with the configurable circuit (140).

Each of the first through fourth helical antennas (121; 124; 127; 130) comprises an upper end disposed on at the top portion, namely a first upper end (123), a second upper end (126), a third upper end (129), and a fourth upper end (131) for the first helical antenna, second helical antenna, third helical antenna, and fourth helical antenna respectively. The first through fourth upper ends terminate at or near the top portion (111) of the cylindrical dielectric (110).

The cylindrical dielectric (110) further comprises a hollow center (113) extending from the top portion (111) to the bottom portion (112). One having skill in the art will appreciate that the hollow center, or aperture, improves efficiency of the quadrifilar helix antenna (100). The hollow center may vary in size.

The antenna assembly (120) is disposed on an antenna assembly substrate (133) having a flexible structure wherein the antenna assembly substrate can subsequently wrap around the cylindrical dielectric (110) to provide a spiral formation of each of the first through fourth helical antennas (121; 124; 127; 130). In other embodiments, the antenna assembly may be disposed directly on the cylindrical dielectric without the antenna assembly substrate as an intermediary.

The first through fourth helical antennas (121; 124; 127; 130) can be twisted or wrapped around the cylindrical dielectric (110) in various configurations as can be appreciated by one having skill in the art. In one illustrated embodiment, each of the first through fourth helical antennas twist less than 360 degrees such that every plan view of the quadrifilar helix antenna (100) displays the first through fourth helical antennas only once. In some embodiments, every plan view of the quadrifilar helix antenna displays each of the first through fourth helical antennas.

The configurable circuit (140) comprises a round shape to match the cylindrical dielectric (110) and provide a compact form factor. The configurable circuit may comprise other shapes as can be appreciated. The configurable circuit is coupled to the bottom portion (112) of the cylindrical dielectric to create either a RHC polarization or a LHC polarization. Alternatively, the configurable circuit can be placed the top portion (111) to change the polarization from RHC to LHC, or from LHC to RHC. The top portion is configured to receive the configurable circuit with the plurality of fasteners coupled to the first through fourth upper ends (123; 126; 129; 132). In another embodiment, the configurable circuit is capable of flipping and reattaching to the bottom portion for change of the polarization.

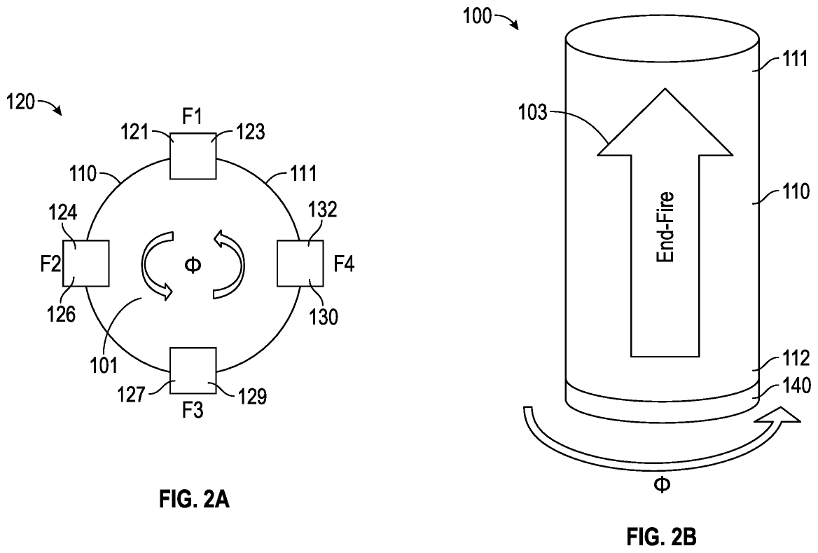

FIG. 2A shows a top view of the configurable quadrifilar helix antenna (100) having a first phasing sequence (101) according to the first illustrated embodiment. The quadrifilar helix antenna comprises a first helical antenna (121), a second helical antenna (124), a third helical antenna (127), and a fourth helical antenna (130) each coupled to a cylindrical dielectric (110). A first upper end (123), a second upper end (126), a third upper end (129), and a fourth upper end (132) of the first through fourth helical antennas, respectively, are disposed at a top portion (111) of the cylindrical dielectric. The quadrifilar helix antenna comprises a first phasing sequence (101) in a counter clockwise orientation thereby causing a first radiation pattern (FIG. 2B, 103). The first phasing sequence is configured by a configurable circuit (FIG. 2B, 140).

FIG. 2B shows a side view of the configurable quadrifilar helix antenna (100) having a first radiation pattern (103) according to the first illustrated embodiment. The quadrifilar helix antenna comprises a cylindrical dialectical (110) having a top portion (111) and a bottom portion (112) wherein a configurable circuit (140) is disposed on the bottom portion. Based on settings of the configurable circuit, the quadrifilar helix antenna comprises a first radiation pattern (103) being an end fire where radiation extends upwards in a direction with the helical antennas.

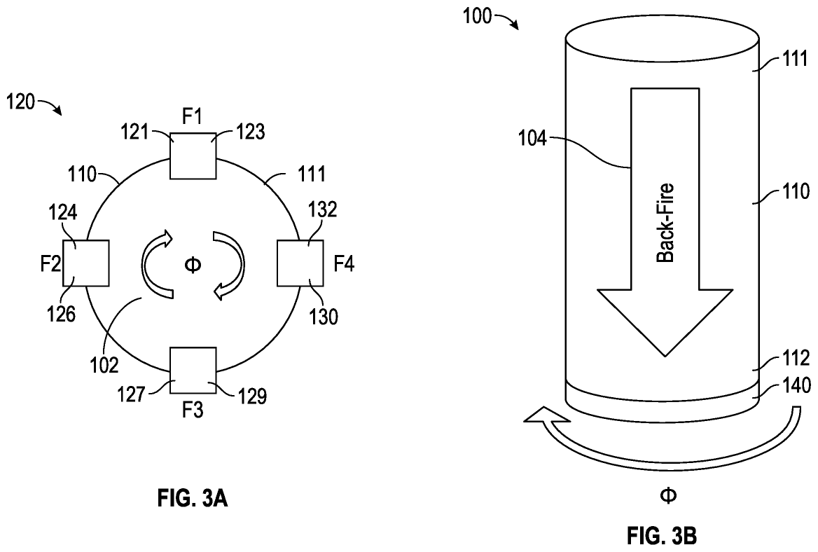

FIG. 3A shows a top view of the of the configurable quadrifilar helix antenna (100) having a second phasing sequence (102) according to the first illustrated embodiment. The quadrifilar helix antenna comprises a first helical antenna (121), a second helical antenna (124), a third helical antenna (127), and a fourth helical antenna (130) each coupled to a cylindrical dielectric. A first upper end (123), a second upper end (126), a third upper end (129), and a fourth upper end (132) of the first through fourth helical antennas, respectively, are disposed at a top portion (111) of the cylindrical dielectric. The quadrifilar helix antenna comprises a second phasing sequence (102) in a clockwise orientation thereby causing a second radiation pattern (FIG. 3B, 104). The second phasing sequence is configured by a configurable circuit (FIG. 3B, 140).

FIG. 3B shows a side view of the configurable quadrifilar helix antenna (100) having a second radiation pattern (104) according to the first illustrated embodiment. The quadrifilar helix antenna comprises a cylindrical dialectical (110) having a top portion (110) and a bottom portion (112) wherein a configurable circuit (140) is disposed on the bottom portion. Based on settings of the configurable circuit, the quadrifilar helix antenna comprises a second radiation pattern (104) being a back fire where radiation extends away from the the helical antennas. The second radiation pattern is in an opposite direction to the first radiation pattern (FIG. 2B, 103).

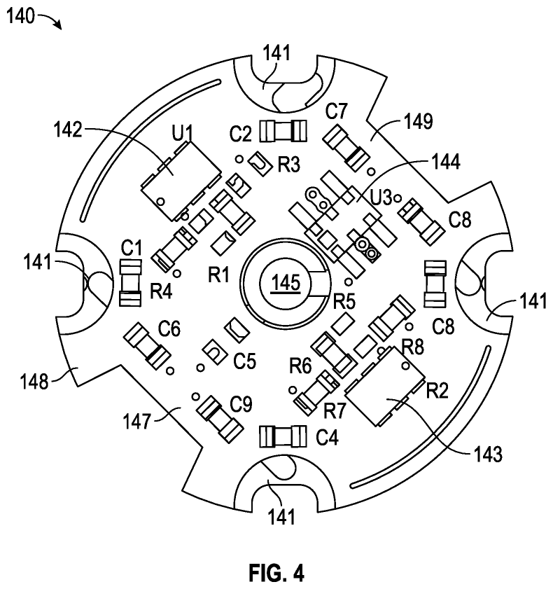

FIG. 4 shows a top view of configurable circuit (140) according to the first illustrated embodiment. The configurable circuit couples to a bottom portion of a cylindrical dielectric. The configurable circuit comprises a substrate (147) having an upper surface (149). Disposed on the upper surface is a plurality of surface mount components including a first hybrid coupler (142) a second hybrid coupler (143), and a power divider (144) electrically coupled to both the first and second hybrid couplers. The substrate further comprises a substrate periphery (148) having a plurality of ports (141) disposed on the substrate periphery. Each of the plurality of ports is associated with one of the first through fourth helical antennas (FIG. 1, 121; 124; 127; 130). One of a plurality of fasteners couples to one of the plurality of ports and further couples to one of the first through fourth helical antennas.

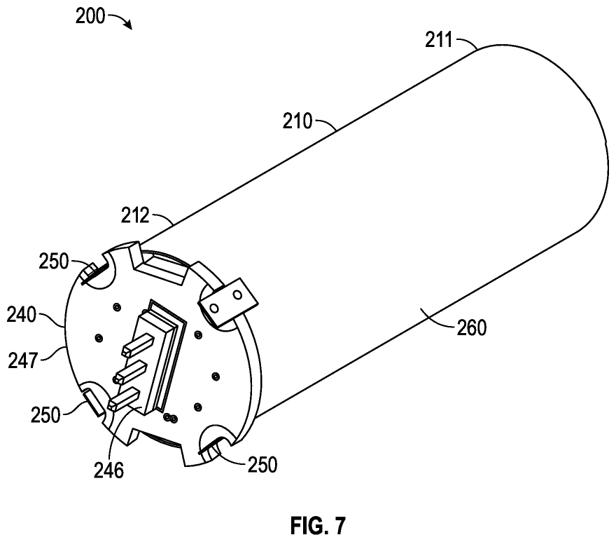

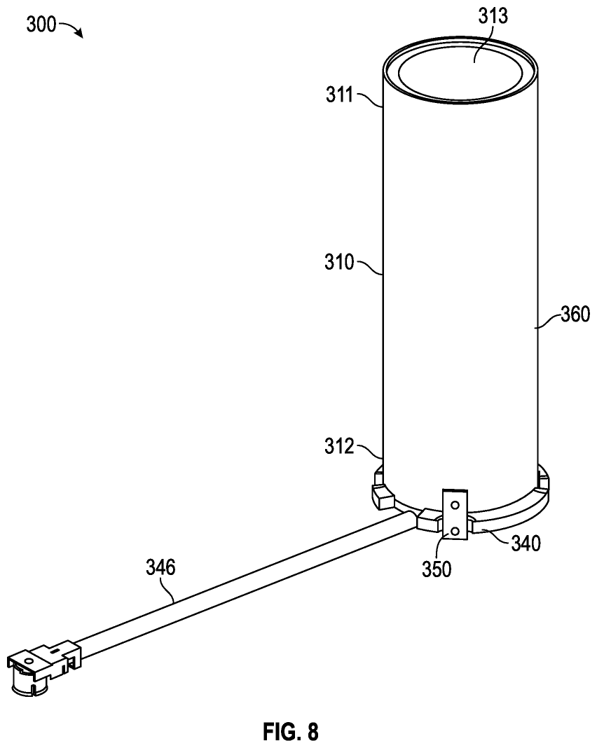

The substrate (147) further comprises a center aperture (145) configured to couple with an antenna connector (FIG. 7, 246; FIG. 8, 346). The antenna connector may comprise a thru-hole mount or may be a cable and connector combination wherein the connector may comprise U.FL, SMA. W.FL or similar circuit connectors. The upper surface (149) of the substrate couples to the bottom portion of the cylindrical dielectric. Each surface mount component therefore is disposed within a hollow center of the cylindrical dielectric. Due to the configurable circuit (140) making contact with the cylindrical dielectric, the cylindrical dielectric being nonconductive is a desirable feature for preventing short circuits.

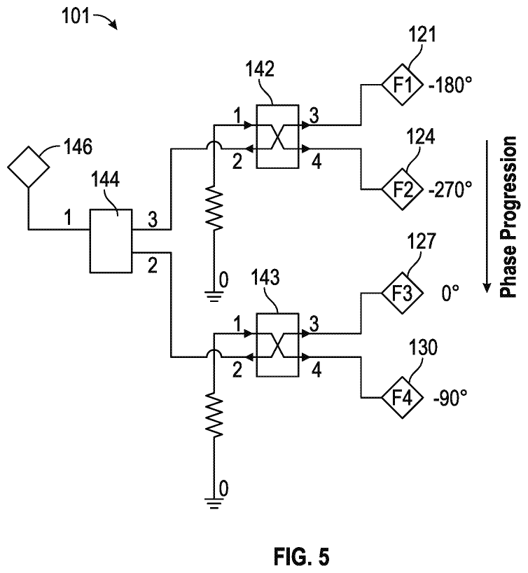

FIG. 5 shows a schematic the first phasing sequence (101) according to the first illustrated embodiment. A signal travels from the antenna connector (146) to a power divider (144), where the signal is then sent to both a first hybrid coupler (142) and a second hybrid coupler (143). Output of each of the first and second hybrid couplers is sent to one of a first through fourth helical antennas (121; 124; 127; 130). As shown, a phase progression of F1=−180°, F2=−270°, F3=0°, and F4=−90° creates a counter clockwise phasing sequence which thereby creates an end fire radiation pattern. An alternative phase progression for an end fire radiation pattern may include F1=−270°, F2=0°, F3=−90°, and F4=−180°. The phase progression as shown is determined by linkage settings of the first and second hybrid couplers.

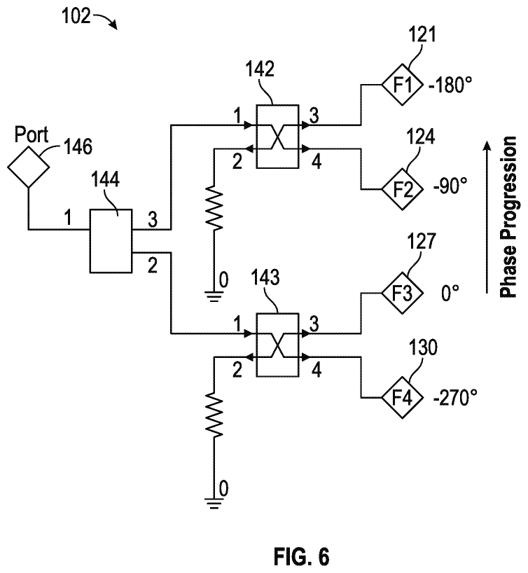

FIG. 6 shows a schematic of the second phasing sequence (102) according to the first illustrated embodiment. A signal travels from the antenna connector (146) to a power divider (144), where the signal is then sent both a first hybrid coupler (142) and a second hybrid coupler (143). Output of each of the first and second hybrid couplers is sent to one of a first through fourth helical antennas (121; 124; 127; 130). As shown, a phase progression of F1=−180°, F2=−90°, F3−0°, and F4=−270° creates a clockwise phasing sequence which thereby creates a back fire radiation pattern. An alternative phase progression for a back fire radiation pattern may include F1=−270°, F2=−180°, F3=−90°, and F4=0°. The phase progression as shown is determined by linkage settings of the first and second hybrid couplers.

FIG. 7 shows a bottom view of a configurable quadrifilar helix antenna (200) in accordance to a second illustrated embodiment. The quadrifilar helix antenna comprises a cylindrical dielectric (210) having a top portion (211) and a bottom portion (212). Wrapped around the cylindrical dielectric is a cover (260) such as a PCB polymer soldermask for protecting a first through fourth helical antennas (not shown) disposed underneath. A configurable circuit (240) is coupled to the bottom portion by a plurality of fasteners (250). An antenna connector (246) is shown disposed on a bottom surface of the configurable circuit. The antenna connector is a thru-hole mount.

FIG. 8 shows a perspective view of a configurable quadrifilar helix antenna (300) in accordance to a third illustrated embodiment. The quadrifilar helix antenna comprises a cylindrical dielectric (310) having a top portion (311) and a bottom portion (312). Wrapped around the cylindrical dielectric is a cover (360) such as a PCB polymer soldermask for protecting a first through fourth helical antennas (not shown) disposed below. A configurable circuit (340) is coupled to the bottom portion by a plurality of fasteners (350). An antenna connector (346) is shown coupled to the configurable circuit. The antenna connector comprises a cable and connector wherein the connector is a U.Fl connector. Other comparable connectors ma also be used to electrically connect the quadrifilar helix antenna to a transmitter.

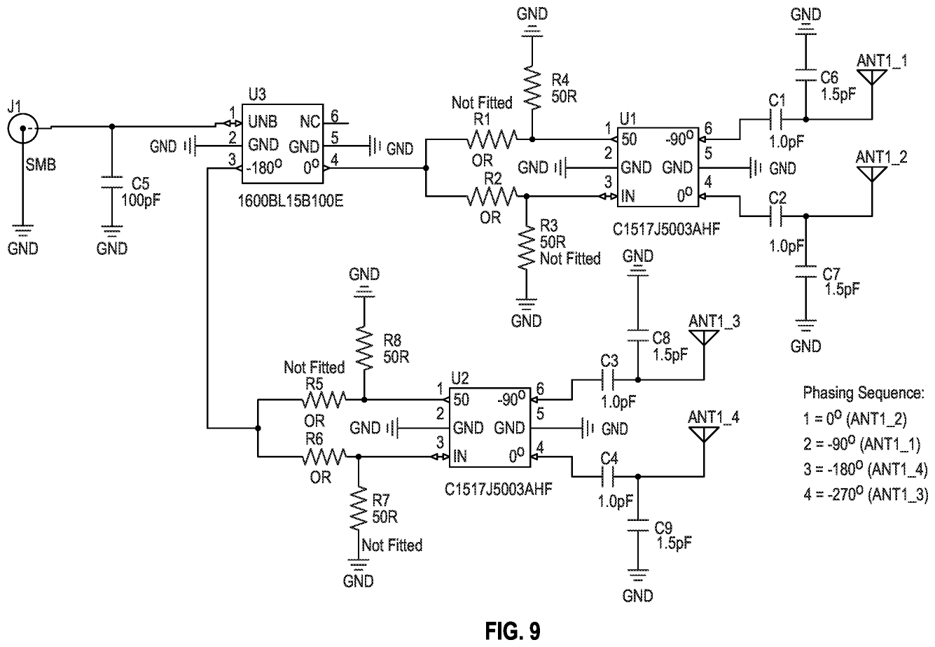

FIG. 9 shows a schematic of the configurable circuit in accordance with a fourth illustrated embodiment. Configurability is achieved by fitting/not fitting components R1, R2, R3, R4, R5, R6, R7 and R8. These resistors come in pairs, namely R1/R2, R3/R4, R5/R6, and R7/R8. When one of the pair is fitted, the other is not fitted. A table of Default and Alternative Configurations is provided below. In some embodiments, Default is end-fire and the Alternative is back-fire. In other embodiments, the Default is back-fire and the Alternative is end-fire.

Configuration

| | Value | Default | Alternative |
|---|---|---|---|
| R1 | 0 | No Fit | Fit |
| R2 | 0 | Fit | No Fit |
| R3 | 50 | No Fit | Fit |
| R4 | 50 | Fit | No Fit |
| R5 | 0 | No Fit | Fit |
| R6 | 0 | Fit | No Fit |
| R7 | 50 | No Fit | Fit |
| R8 | 50 | Fit | No Fit |

### FEATURE LIST

quadrifilar helix antenna (100; 200; 300)
first phasing sequence (101)
second phasing sequence (102)
first radiation pattern (103)
second radiation pattern (104)
cylindrical dielectric (110; 210; 310)
top portion (111; 211; 311)
bottom portion (112; 212; 312)
hollow center (113; 313)
antenna assembly (120)
first helical antenna (121)
first lower end (122)
first upper end (123)
second helical antenna (124)
second lower end (125)
second upper end (126)
third helical antenna (127)
third lower end (128)
third upper end (129)
fourth helical antenna (130)
fourth lower end (131)
fourth upper end (132)
antenna assembly substrate (133)
configurable circuit (140; 240; 340)
plurality of ports (141)
first hybrid coupler (142)
second hybrid coupler (143)
power divider (144)
center aperture (145)
antenna connector (146; 246; 346)
substrate (147; 247)
substrate periphery (148)
upper surface (149)
plurality of fasteners (150; 250; 350)
helical antenna cover (260; 360)

What is claimed is:

1. A configurable helix antenna, comprising:
a cylindrical dielectric having top portion and a bottom portion opposite the top portion, and a hollow center extending through the cylindrical dielectric;
an antenna assembly comprising:
a first helical antenna having a first lower end and a first upper end opposite the first lower end,
a second helical antenna having a second lower end and a second upper end opposite the second lower end,
a third helical antenna having a third lower end and a third upper end opposite the third lower end, and
a fourth helical antenna having a fourth lower end and a fourth upper end opposite the fourth lower end,
wherein the first through fourth helical antenna each spiral around the cylindrical substrate;
a configurable circuit disposed at the bottom portion, the configurable circuit comprising:
a substrate having a substrate periphery,
a plurality of ports disposed on the substrate periphery, and
a first hybrid coupler and a second hybrid coupler, wherein the first and second hybrid couplers are configured to alternate phasing sequence of the configurable helix antenna from a first phasing sequence having a first radiation pattern to a second phasing sequence having a second radiation pattern,
a power divider electrically coupled to each of the first and second hybrid couplers; and
a plurality of fasteners each coupled to the antenna assembly and further coupled to the configurable circuit.

2. The configurable helix antenna of claim 1, the plurality of fasteners further comprising soldered tabs.

3. The configurable helix antenna of claim 1, wherein the first lower end, second lower end, third lower end, and fourth lower end are each coupled to one of the plurality of ports.

4. The configurable helix antenna of claim 1, wherein the top portion is configured to receive the configurable circuit.

5. The configurable helix antenna of claim 1, wherein the first through fourth helical antenna comprise a 90-degree phase shift.

6. The configurable helix antenna of claim 1, wherein the first hybrid coupler and second coupler each comprise a quadrature coupler.

7. The configurable helix antenna of claim 1, the configurable circuit further comprising an antenna connector wherein the antenna connector comprises a cable.

8. The configurable helix antenna of claim 1, the configurable circuit further comprising an antenna connector wherein the antenna connector comprises a thru-hole mount.

9. The configurable helix antenna of claim 1, the configurable circuit further comprising a center aperture configured to receive an antenna connector.

10. The configurable helix antenna of claim 1, wherein the first through fourth helical antenna are each disposed on an antenna assembly substrate, the antenna assembly substrate being wrapped around the cylindrical dielectric.

11. A configurable helix antenna, comprising:
a cylindrical dielectric having top portion and a bottom portion opposite the top portion;
an antenna assembly comprising a plurality of helical antennas wherein each of the plurality of helical antenna twists around the cylindrical dielectric and further wherein each of the plurality of helical antennas is disposed on an outer surface of the cylindrical dielectric; and
a configurable circuit disposed at the bottom portion of the cylindrical dielectric, the configurable circuit comprising a first hybrid coupler and a second hybrid coupler, wherein the first and second hybrid couplers are configured to alternate phasing sequence of the configurable helix antenna from a first phasing sequence having a first radiation pattern to a second phasing sequence having a second radiation pattern; the configurable circuit further comprising:
a substrate having a substrate periphery, and
a plurality of ports disposed on the substrate periphery.

12. The configurable helix antenna of claim 11, the plurality of helical antennas further comprising:
a first helical antenna having a first lower end and a first upper end opposite the first lower end;
a second helical antenna having a second lower end and a second upper end opposite the second lower end;
a third helical antenna having a third lower end and a third upper end opposite the third lower end; and
a fourth helical antenna having a fourth lower end and a fourth upper end opposite the fourth lower end.

13. The configurable helix antenna of claim 11, the cylindrical dielectric further comprising a hollow center extending therethrough.

14. (canceled)

15. The configurable helix antenna of claim 11, wherein the first through fourth helical antenna comprise a 90-degree phase shift.

16. The configurable helix antenna of claim 11, wherein the first hybrid coupler and second coupler each comprise a quadrature coupler.

17. The configurable helix antenna of claim 11, the configurable circuit further comprising an antenna connector wherein the antenna connector comprises a cable.

18. The configurable helix antenna of claim 11, the configurable circuit further comprising an antenna connector wherein the antenna connector comprises a thru-hole mount.

19. The configurable helix antenna of claim 11, further comprising a plurality of fasteners each coupled to the antenna assembly and further coupled to the configurable circuit.

20. The configurable helix antenna of claim 11, the configurable circuit further comprising a power divider electrically coupled to both the first and second hybrid couplers.
